(19) United States
(12) Patent Application Publication
(10) Pub. No.: US 2020/0101705 A1
(43) Pub. Date: Apr. 2, 2020

(54) AUTOMOBILE INTERIOR COMPONENT AND METHOD FOR MANUFACTURING SAME

(71) Applicant: FUJI BAKELITE CO., LTD., Okayama (JP)

(72) Inventors: Takaki SAKAMOTO, Fukuyama-shi, Hiroshima (JP); Yasuhiro MITSUI, Soja-shi, Okayama (JP)

(73) Assignee: FUJI BAKELITE CO., LTD., Okayama (JP)

(21) Appl. No.: 16/604,784

(22) PCT Filed: Aug. 25, 2017
(86) PCT No.: PCT/JP2017/030638

§ 371 Date: Oct. 11, 2019

(30) Foreign Application Priority Data
Apr. 14, 2017 (JP) 2017-080883

(51) Int. Cl. B32B 27/36; C08L 69/00; C08L 55/02; B60R 13/02; B29C 45/00; B29C 45/16; B32B 27/08; B32B 3/26

(52) U.S. Cl. CPC B32B 27/365; C08L 69/00; C08L 55/02; B60R 13/02; B29C 45/0001; B29K 2069/00; B32B 27/08; B32B 3/266; C08L 2205/025; C08L 2205/03; B29C 45/1615

(57) ABSTRACT

There is provided an automobile interior component comprising a base material and a surface layer formed thereon, wherein the base material is made of an alloy of a bisphenol-A polycarbonate resin and an ABS resin; the surface layer is made of a polycarbonate resin having a pencil hardness of HB or higher in accordance with ASTM D3363; a thickness of the surface layer is 0.5 to 5 mm; and the base material and the surface layer are formed by insert molding or two-color molding such that the surface layer is to be a design surface. This automobile interior component has excellent shock resistance and scratch resistance.

### TECHNICAL FIELD

The present invention relates to an automobile interior component comprising a base material and a surface layer formed thereon, as well as a production method therefor.

### BACKGROUND ART

Conventionally, a resin is molded by a known method such as insert molding and two-color molding. Insert molding is a molding method comprising injecting a resin such that it is in contact with a surface of a member mounted inside of a mold to fill the cavity with the resin, and integrally molding the resin with the member. Two-color molding is a method comprising injecting two different types of resins into a mold in sequence from an injection nozzle to form a molded article made of a plurality of resins. It is believed that such molding methods can provide a complex shape of multilayer molded article with a reduced number of steps.

Patent Reference No. 1 has disclosed a multilayer molded article comprising a translucent or opaque base layer and a surface layer formed on the surface of the base layer by two-color molding or insert molding, wherein the surface layer is made of a colorless and transparent resin or a dye-containing transparent resin. Examples of the resin used herein include a polymethyl methacrylate resin, a methyl methacrylate-acrylonitrile-butadiene-styrene resin, a syndiotactic polystyrene resin, a polyamide resin, a polycarbonate resin, and an epoxy resin.

Patent Reference No. 2 has described a method for producing a molded resin article by injection molding. The molded resin article consists of a molded part made of a transparent resin and a molded part made of an opaque resin on the rear surface of the former molded part, wherein the mold used for the injection molding consists of a design-side mold and a non-design-side mold. The design-side mold has a cavity for forming the transparent resin molding part, while the non-design-side mold has a cavity for forming the opaque resin molding part. There has been disclosed a method for producing a molded resin article comprising injection molding wherein a temperature of the non-design-side mold is lower than a temperature of the design-side mold and a difference between a temperature of the non-design-side mold and a temperature of the design-side mold is less than 20° C. It is described that the transparent resin and the opaque resin are suitably a polycarbonate resin containing structural units derived from isosorbide.

Recently, there have been attempts for producing an interior component of an automobile by insert molding or two-color molding. An interior component of an automobile is required to be highly shock-resistant in the light of safety. Meanwhile, since an interior component such as an audio panel is seen by a user, it is required to have a good appearance. Furthermore, if it is poorly scratch-resistant, switch operation of an audio may easily cause damage, so that good appearance cannot be maintained. Molded articles and molded resin articles described in Patent Reference Nos. 1 and 2 do not meet performance requirement as an interior component of an automobile in terms of shock resistance and scratch resistance.

### PRIOR ART REFERENCES

### Patent References

Patent Reference No. 1: JP 201 1-681 23 A

Patent Reference No. 2: JP 2015-112841 A

### SUMMARY OF THE INVENTION

### Problems to be Solved by the Invention

To solve the above problems, an objective of the present invention is to provide an automobile interior component having excellent shock resistance and scratch resistance as well as a production method therefor.

### Means for Solving the Problems

The above problems can be solved by providing an automobile interior component comprising a base material and a surface layer formed thereon, wherein the base material is made of an alloy of a bisphenol-A polycarbonate resin and an ABS resin; the surface layer is made of a polycarbonate resin having a pencil hardness of HB or higher in accordance with ASTM D3363; a thickness of the surface layer is 0.5 to 5 mm; and the base material and the surface layer are formed by insert molding or two-color molding such that the surface layer is to be a design surface.

Preferably, the surface layer is made of a polycarbonate resin comprising structural units derived from isosorbide; an alloy of a bisphenol-A polycarbonate resin and a bisphenol-C polycarbonate resin; or a polycarbonate resin comprising structural units derived from bisphenol A and bisphenol C.

Preferably, a total light transmittance of the base material is 10% or less; and a total light transmittance of the surface layer is 20% or more. A total light transmittance of the surface layer is also preferably 80% or less.

Preferably, the base material has a through-hole in which the surface layer is absent. Also preferably, the surface layer is formed in a part of the through-hole.

The above problems can be also solved by providing a method for producing the above automobile interior component, comprising a first step: injecting an alloy of a bisphenol-A polycarbonate resin and an ABS resin into a cavity formed in a mold for a base material, to mold a base material; a second step: removing the base material from the mold; a third step: mounting the removed base material on a mold for a surface layer; a fourth step: injecting a polycarbonate resin having a pencil hardness of HB or higher in accordance with ASTM D3363 into a cavity formed in the mold for a surface layer, to form a surface layer on the base material; and a fifth step: removing a multilayer molded article from the mold for a surface layer.

The above problems can be also solved by providing a method for producing the above automobile interior component, comprising a first step: injecting a polycarbonate resin having a pencil hardness of HB or higher in accordance with ASTM D3363 into a cavity formed in a mold for a surface layer, to form a surface member; a second step: removing the surface member from the mold; a third step: mounting the removed surface member on a mold for a base material; a fourth step: injecting an alloy of a bisphenol-A polycarbonate resin and an ABS resin into a cavity formed in the mold for a base material, to form a base material under the surface member; and a fifth step: removing a multilayer molded article from the mold for a base material.

The above problems can be also solved by providing a method for producing the above automobile interior component, comprising a first step: injecting an alloy of a bisphenol-A polycarbonate resin and an ABS resin into a cavity for a base material formed between a common mold and a first interchangeable mold; a second step: replacing the first interchangeable mold with a second interchangeable mold; a third step: injecting a polycarbonate resin having a pencil hardness of HB or higher in accordance with ASTM D3363 into a cavity for a surface layer formed between the common mold and the second interchangeable mold; and a fourth step: cooling the common mold and the second interchangeable mold, and then removing a multilayer molded article from the common mold and the second interchangeable mold.

The above problems can be also solved by providing a method for producing the above automobile interior component, comprising a first step: injecting a polycarbonate resin having a pencil hardness of HB or higher in accordance with ASTM D3363 into a cavity for a surface layer formed between a common mold and a first interchangeable mold; a second step: replacing the first interchangeable mold with a second interchangeable mold; a third step: injecting an alloy of a bisphenol-A polycarbonate resin and an ABS resin into a cavity for a base material formed between the common mold and the second interchangeable mold; and a fourth step: cooling the common mold and the second interchangeable mold, and removing a multilayer molded article from the common mold and the second interchangeable mold.

### Effects of the Invention

According to the present invention, there can be provided an automobile interior component having excellent shock resistance and scratch resistance.

### BRIEF DESCRIPTION OF THE DRAWINGS

FIG. 1 shows an example of an interior component.

FIG. 2 is a cross-section taken on line A-A in FIG. 1.

### MODES FOR CARRYING OUT THE INVENTION

The present invention relates to an automobile interior component comprising a base material and a surface layer formed thereon. Herein, it is important that the base material is made of an alloy of a bisphenol-A polycarbonate resin and an ABS resin, and that the surface layer is made of a polycarbonate resin having a pencil hardness of HB or higher in accordance with ASTM D3363. After intense investigation, the inventors have found that a base material made of the above alloy and a surface layer made of the above polycarbonate resin are formed by insert molding or two-color molding such that the surface layer is to be a design surface (the surface which a user can see), giving an interior component consisting of a multilayer molded article having excellent shock resistance and scratch resistance, and have achieved the present invention.

A base material in the present invention is made of an alloy of a bisphenol-A polycarbonate resin and an ABS resin. The alloy herein is a polymer blend of a bisphenol-A polycarbonate resin and an ABS resin. This polymer blend can contain, for example, additives. For an automobile interior component of the present invention, it is important that a base material is made of an alloy of a bisphenol-A polycarbonate resin and an ABS resin. The use of the alloy for the base material allows for producing a multilayer molded article with a polycarbonate resin having a pencil hardness of HB or higher in accordance with ASTM D3363 with higher shock resistance than that produced using a bisphenol-A polycarbonate resin alone or an ABS resin alone, as seen in Examples later.

A mass ratio [(PC-A)/(ABS)] of a bisphenol-A polycarbonate resin (PC-A) to an ABS resin (ABS) in an alloy of the bisphenol-A polycarbonate resin and the ABS resin is generally, but not limited to, 90/10 to 10/90. The bisphenol-A polycarbonate resin can be generally produced by a known method such as interfacial polycondensation of bisphenol A and phosgene in the presence of an alkali catalyst and melt polycondensation of bisphenol A and diphenyl carbonate. The ABS resin can be produced by a known method such as blending, grafting and graft-blending. An alloy of a bisphenol-A polycarbonate resin and an ABS resin is readily commercially available under a trade name “Multilon” from Teijin Limited.

A resin constituting a surface layer in the present invention is a polycarbonate resin having a pencil hardness of HB or higher in accordance with ASTM D3363. An interior component is often used in a part touched by a user. Therefore, the surface layer must not be scratched, and the resin constituting a surface layer must have a high pencil hardness. The pencil hardness is preferably F or higher, more preferably H or higher, further preferably 2H or higher. It is believed that an acrylic resin has a relatively higher pencil hardness and excellent scratch resistance, but has lower shock resistance. Furthermore, an ABS resin is not frequently used in an interior component for an automobile due to its poor heat resistance and scratch resistance.

The surface layer is preferably a polycarbonate resin containing structural units derived from isosorbide. The surface layer made of such a resin allows for providing an interior component having excellent shock resistance and scratch resistance, maintaining heat resistance.

The polycarbonate resin containing structural units derived from isosorbide can be produced by transesterification between isosorbide and a carbonic acid diester. Isosorbide can be produced by dehydration concentration of sorbitol produced from starch. Examples of a carbonic acid diester include diphenyl carbonate, ditolyl carbonate, dimethyl carbonate, diethyl carbonate and di-t-butyl carbonate. A proportion of a molar number of the structural units derived from isosorbide to a molar number of monomer units constituting the above polycarbonate is, but not limited to, generally 20 mol % or more, suitably 40 mol % or more. The polycarbonate resin containing structural units derived from isosorbide is readily commercially available, for example, under a trade name “ DURABIO” from Mitsubishi Chemical Corporation.

Also preferably, the surface layer is made of an alloy of a bisphenol-A polycarbonate resin and a bisphenol-C polycarbonate resin. The surface layer made of such a resin allows for providing an interior component having excellent shock resistance and scratch resistance, maintaining heat resistance. The alloy herein is a polymer blend of a bisphenol-A polycarbonate resin and a bisphenol-C polycarbonate resin. This polymer blend can further contain, for example, additives.

A mass ratio [(PC-A)/(PC-C)] of a bisphenol-A polycarbonate resin (PC-A) to a bisphenol-C polycarbonate resin (PC-C) in an alloy of the bisphenol-A polycarbonate resin and the bisphenol-C polycarbonate resin is generally, but not limited to, 90/10 to 10/90. A content of components other than the bisphenol-A polycarbonate resin and the bisphenol-C polycarbonate resin in the alloy is, but not limited to, generally 20% by mass or less, suitably 10% by mass or less, more suitably 5% by mass or less. The bisphenol-A polycarbonate resin can be produced as described above. The bisphenol-C polycarbonate resin can be also produced by a known method such as interfacial polycondensation of bisphenol C and phosgene in the presence of an alkali catalyst and melt polycondensation of bisphenol C and diphenyl carbonate. An alloy of a bisphenol-A polycarbonate resin and a bisphenol-C polycarbonate resin is readily commercially available, for example, under a trade name “lupilon” from Mitsubishi Engineering-Plastics Corporation.

It is also preferable that the surface layer is made of a polycarbonate resin containing structural units derived from bisphenol A and bisphenol C. The surface layer made of a resin consisting of such a copolymer allows for providing an interior component having excellent shock resistance and scratch resistance, maintaining heat resistance. A proportion of a total molar number of the structural units derived from bisphenol A and the structural units derived from bisphenol C to a molar number of the whole monomers constituting the polycarbonate resin is, but not limited to, generally 80 mol % or more, suitably 90 mol % or more, more suitably 95 mol % or more. A molar ratio [(BPA)/(BPC)] of the structural units derived from bisphenol A to the structural units derived from bisphenol C in the polycarbonate resin is, but not limited to, generally 90/10 to 10/90. The polycarbonate resin can contain other components such as additives. A content of the other components is generally 10% by mass or less, suitably 5% by mass or less.

There are no particular restrictions to a method for producing a polycarbonate resin containing structural units derived from bisphenol A and from bisphenol C, and it can be generally produced by transesterification of a diol component (bisphenol A and bisphenol C) with a carbonic acid diester. A polycarbonate resin containing structural units derived from bisphenol A and bisphenol C is readily commercially available, for example, under a trade name “Panlite” from Teijin Limited.

Preferably, an automobile interior component of the present invention is an insert molded article or a two-color molded article comprising a base material made of an alloy of a bisphenol-A polycarbonate resin and an ABS resin; and a surface layer made of a polycarbonate resin containing structural units derived from isosorbide, an alloy of a bisphenol-A polycarbonate resin and a bisphenol-C polycarbonate resin, or a polycarbonate resin containing structural units derived from bisphenol A and bisphenol C. In such a multilayer molded article, solvent cracks tend not to generate in comparison with a monolayer molded article made of a polycarbonate resin containing structural units derived from isosorbide.

A polycarbonate resin containing structural units derived from isosorbide, an alloy of a bisphenol-A polycarbonate resin and a bisphenol-C polycarbonate resin, and a polycarbonate resin containing structural units derived from bisphenol A and bisphenol C can be used properly, depending on required performance for an interior component. When prevention of optical strain and chemical resistance are stressed, the surface layer is preferably made of a polycarbonate resin containing structural units derived from isosorbide. When scratch resistance of a design surface is stressed, the surface layer is preferably made of an alloy of a bisphenol-A polycarbonate resin and a bisphenol-C polycarbonate resin, or a polycarbonate resin containing structural units derived from bisphenol A and bisphenol C. In the present invention, a thickness of the surface layer is 0.5 to 5 mm. With a thickness of the surface layer within this range, an interior component having excellent shock resistance and design can be provided. If a thickness of the surface layer is less than 0.5 mm, an article produced cannot meet shock resistance required as an interior component for an automobile. A thickness of the surface layer is preferably 1 mm or more. If a thickness of the surface layer is more than 5 mm, a production cost may increase. Furthermore, it is undesirable in the light of weight saving of an automobile. Furthermore, an interior component with a good appearance may not be provided. A thickness of the surface layer is preferably 3 mm or less.

A thickness of a base material is appropriately determined, taking a production cost and/or strength into account, and is preferably 0.5 to 5 mm. If a thickness of a base material is less than 0.5 mm, an article produced cannot meet shock resistance required as an interior component for an automobile. A thickness of a base material is preferably 1 mm or more. If a thickness of a base material is more than 5 mm, a production cost may increase. Furthermore, it is undesirable in the light of weight saving of an automobile. A thickness of a base material is preferably 3 mm or less.

In the present invention, it is preferable that a total light transmittance of a base material is 10% or less and a total light transmittance of a surface layer is 20% or more. With a total light transmittance of the base material and the surface layer as described above, a design surface has a glossy and high-class appearance. A total light transmittance of a base material and a surface layer can be adjusted by adding a colorant such as a pigment and a dye to a resin for a base material or a resin constituting a surface layer. There are no particular restrictions to color of a colorant, and various colors of colorants can be used. For example, when a base material contains a black pigment, it is sometimes called as jet black, piano black or piano-like black, which has particularly large market needs. When a base material or a surface layer contains a pigment called as a metallic pigment or a pearl pigment, it allows for an appearance providing different hue, depending on a viewing direction or a light direction. A total light transmittance of the base material is more preferably 8% or less, further preferably 5% or less, particularly preferably 3% or less, most preferably substantially 0%. Meanwhile, a total light transmittance of the surface layer is more preferably 25% or more, further preferably 30% or more.

When a surface layer has an extremely higher total light transmittance, an glossy and deep appearance may not be obtained. In this light, a total light transmittance of the surface layer is preferably 80% or less, more preferably 70% or less, further preferably 60% or less. A total light transmittance is measured in accordance with JIS K7361-1 (1997).

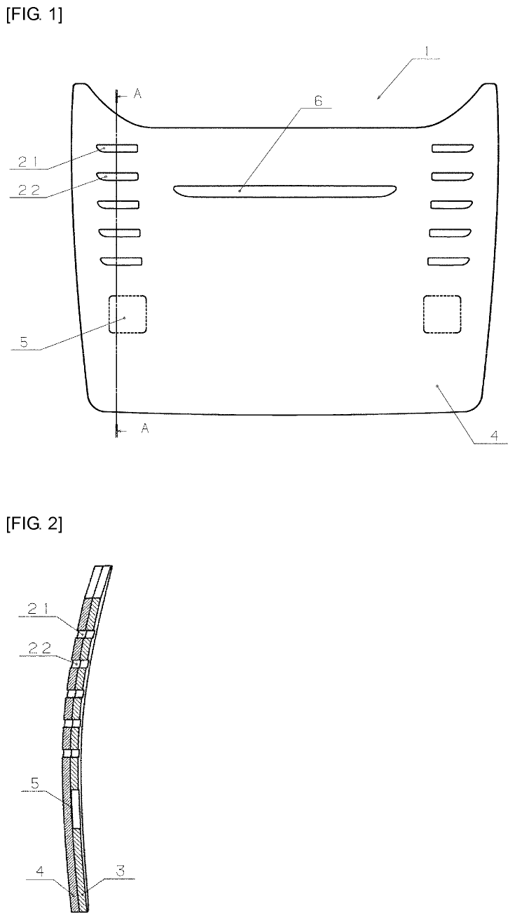

In the present invention, it is preferable that the base material has a through-hole, and in the through-hole, the surface layer is absent. It is also preferable that the surface layer is formed in a part of the through-holes. Here, there will be described suitable embodiments of the present invention with reference to Figures. FIG. 1 shows an example of an interior component of the present invention. As shown in FIG. 1, an interior component 1 has a plurality of through-holes (21, 22, and so on) penetrating both base material 3 and surface layer 4. FIG. 2 is a cross-section taken on line A-A in FIG. 1. As shown in FIG. 2, the surface layer 4 is formed on the base material 3 such that the surface layer 4 is to be a design surface. A through-hole in the base material 3 partly has a surface-layer forming part 5 where the surface layer 4 is formed.

When the interior component 1 in FIG. 1 is used as, for example, an audio panel, a power button and a play/stop button are disposed in through-holes (21, 22 and so on), whereby the audio can be operated on the design surface. A surface-layer forming part 5 becomes a display window displaying texts and/or patterns. Specifically, on the rear side of the display window is disposed a light-emitting diode (LED) or the like, whereby texts and/or patterns are luminescent-displayed. An opening 6 is, for example, an insertion opening for a CD.

An automobile interior component of the present invention is a multilayer molded article wherein a base material and a surface layer are formed by insert molding or two-color molding such that the surface layer is to be a design surface. Here, insert molding is a molding method comprising injecting a resin such that it is in contact with a surface of a member mounted inside of a mold to fill the cavity with the resin, and integrally molding the resin with the member. Two-color molding is a method comprising injecting two different types of resins into a mold in sequence from an injection nozzle to form a molded article made of a plurality of resins. Two-color molding is sometimes referred to as “multicolor molding” or “multiple molding”.

In general, insert molding has the advantage that a facility cost and a production cost for a mold are inexpensive in comparison with two-color molding. In contrast, two-color molding has the advantage that a production efficiency is higher in comparison with insert molding. For high-mix low-volume production, insert molding is preferable, while for large-scale production of the same shape product, two-color molding is preferable. Either insert molding or two-color molding is selected in the light of a production cost and a production efficiency.

There are no particular restrictions to a method for insert molding in the present invention, but the following method (i) or (ii) is suitable.

### Method (i)

Method (i) is a method, comprising a first step: injecting an alloy of a bisphenol-A polycarbonate resin and an ABS resin into a cavity formed in a mold for a base material, to mold a base material; a second step: removing the base material from the mold; a third step: mounting the removed base material on a mold for a surface layer; a fourth step: injecting a polycarbonate resin having a pencil hardness of HB or higher in accordance with ASTM D3363 into a cavity formed in the mold for a surface layer, to form a surface layer on the base material; and a fifth step: removing a multilayer molded article from the mold for a surface layer.

In Step 1, an alloy of a bisphenol-A polycarbonate resin and an ABS resin is injected into a cavity formed in a mold for a base material to form a base material. Here, the mold can consist of one positive die and one female die, or a plurality of these. The surface of a mold used in Step 1 can be smooth or patterned. By using a mold having a patterned surface, the pattern is transferred to the surface of the base material, and the pattern is visible through a surface layer and thus, an interior component having excellent design properties can be provided. Although there are no particular restrictions to the molding conditions during injection molding, a cylinder preset temperature is preferably 220 to 330° C. during the molding. Then, in subsequent Step 2, a base material molded is removed from the mold for a base material.

In Step 3, the base material removed from the mold for a base material is mounted to a mold for a surface layer. In Step 3, the base material obtained in Step 2 can be mounted to a mold for a surface layer without being cooled to room temperature, or after being cooled to room temperature. By cooling the base material to room temperature, a time for relaxing a residual stress in the base material can be ensured and dimensional accuracy of an interior component can be improved. When the base material is mounted to the mold for a surface layer without being cooled, adhesion between the base material and the surface layer can be improved.

In Step 4, a polycarbonate resin having a pencil hardness of HB or higher in accordance with ASTM D3363 is injected into a cavity formed in the mold for a surface layer, to form a surface layer on the base material. Here, the mold can consist of one positive die and one female die, or a plurality of these. The surface of a mold used in Step 4 can be smooth or patterned. By using a mold having a patterned surface, the pattern is transferred to the surface layer, so that a pattern can be formed in the surface of an interior component obtained. In subsequent Step 5, a multilayer molded article is removed from the mold for a surface layer to obtain an interior component.

For improving chemical resistance and a design of an interior component, the design surface of the interior component can be surface-treated after Step 5. For example, the design surface can be coated or plated. Coating can be conducted by, for example, spray coating, brush painting, electrodeposition coating, electrostatic coating and ultraviolet curing coating. Plating can be conducted by electroplating, electroless plating and vapor deposition. Alternatively, a film can be laminated on the design surface of the interior component. The film used herein can be, for example, an anti-glare film (antireflection film) or an anti-finger film (anti-fingerprint film). Furthermore, the design surface of the interior component can be coarsened by etching or blasting. Such surface treatment can be conducted multiple times, where the types of the surface treatment can be the same or different.

### Method (ii)

Method (ii) is a method comprising a first step: injecting a polycarbonate resin having a pencil hardness of HB or higher in accordance with ASTM D3363 into a cavity formed in a mold for a surface layer, to form a surface member; a second step: removing the surface member from the mold; a third step: mounting the removed surface member on a mold for a base material; a fourth step: injecting an alloy of a bisphenol-A polycarbonate resin and an ABS resin into a cavity formed in the mold for a base material, to form a base material under the surface member; and a fifth step: removing a multilayer molded article from the mold for a base material.

Unlike Method (i), Method (ii) is a method wherein in Step 1, a polycarbonate resin having a pencil hardness of HB or higher in accordance with ASTM D3363 is injected into a cavity formed in a mold for a surface layer to form a surface member; and in later Step 4, an alloy of a bisphenol-A polycarbonate resin and an ABS resin is injected into a cavity formed in the mold for a base material, to form a base material under the surface member.

Steps 2, 3 and 5 in Method (ii) correspond to Steps 2, 3 and 5, respectively, in Method (i), and so, are not detailed. The mold used in Method (ii) can consist of one positive die and one female die, or a plurality of these. The surface of the mold can be smooth or patterned. In Method (ii), again, a surface member can be mounted to a mold for a base material without being cooled to room temperature, or after being cooled to room temperature. The design surface of the interior component obtained by Method (ii) can be surface-treated as described above.

Either Method (i) or (ii) can be appropriately selected, taking a production cost and/or a production efficiency into consideration.

Two-color molding in the present invention is suitably , but not limited to, Method (iii) or (iv) described below.

### Method (iii)

Method (iii) is a method comprising a first step: injecting an alloy of a bisphenol-A polycarbonate resin and an ABS resin into a cavity for a base material formed between a common mold and a first interchangeable mold; a second step: replacing the first interchangeable mold with a second interchangeable mold; a third step: injecting a polycarbonate resin having a pencil hardness of HB or higher in accordance with ASTM D3363 into a cavity for a surface layer formed between the common mold and the second interchangeable mold; and a fourth step: cooling the common mold and the second interchangeable mold, and then removing a multilayer molded article from the common mold and the second interchangeable mold.

In Step 1, an alloy of a bisphenol-A polycarbonate resin and an ABS resin is injected into a cavity for a base material formed between a common mold and a first interchangeable mold. By injecting the above alloy into a cavity for a base material, a primary molded article corresponding to a base material of an interior component is molded. By designing a cavity for a base material depending on a product shape, a through-hole or a surface-layer forming part, for example, as shown in FIG. 1 can be formed. There are no particular restrictions to the molding conditions during injection molding, but a cylinder preset temperature is preferably 200 to 330° C. during the molding. The common mold and the first interchangeable mold can consist of a plurality of molds, respectively. Furthermore, the surface of these molds can be smooth or patterned. By using a mold having a patterned surface, the pattern is transferred to the surface of the base material, and the pattern is visible through a surface layer and thus, an interior component having excellent design properties can be provided.

Then, the alloy is injected into a cavity for a base material, mold clamped, compressed and cooled, and in subsequent Step 2, a first interchangeable mold is replaced with a second interchangeable mold.

In Step 3, a polycarbonate resin having a pencil hardness of HB or higher in accordance with ASTM D3363 is injected into a cavity for a surface layer formed between a common mold and a second interchangeable mold. By injecting the polycarbonate resin into the cavity for a surface layer, a secondary molded article corresponding to a surface layer of an interior component is formed on the primary molded article. The cavity for a surface layer can be designed depending on the shape of a product, so that a through-hole and a surface-layer forming part as shown in FIG. 1 can be formed. There are no particular restrictions to the molding conditions during injection molding, but a cylinder preset temperature is preferably 200 to 350° C. during the molding.

The surface of the second interchangeable mold used in Step 3 can be smooth or patterned. By using a second interchangeable mold having a pattern in the surface, the pattern is transferred to a secondary molded article, so that a pattern can be formed in the design surface. The second interchangeable mold can consist of a plurality of molds.

In subsequent Step 4, the common mold and the second interchangeable mold are cooled, and then, a multilayer molded article is removed from the common mold and the second interchangeable mold, to provide an interior component. The design surface of the interior component obtained by Method (iii) can be surface-treated as described above.

### Method (iv)

Method (iv) is a method comprising a first step: injecting a polycarbonate resin having a pencil hardness of HB or higher in accordance with ASTM D3363 into a cavity for a surface layer formed between a common mold and a first interchangeable mold; a second step: replacing the first interchangeable mold with a second interchangeable mold; a third step:

injecting an alloy of a bisphenol-A polycarbonate resin and an ABS resin into a cavity for a base material formed between the common mold and the second interchangeable mold; and a fourth step: cooling the common mold and the second interchangeable mold, and removing a multilayer molded article from the common mold and the second interchangeable mold.

Unlike Method (iii), Method (iv) is a method wherein in Step 1, a polycarbonate resin having a pencil hardness of HB or higher in accordance with ASTM D3363 is injected into a cavity for a surface layer formed between a common mold and a first interchangeable mold, and in later Step 3, an alloy of a bisphenol-A polycarbonate resin and an ABS resin is injected into a cavity for a base material formed between the common mold and a second interchangeable mold.

Steps 2 and 4 in Method (iv) correspond to Steps 2 and 4, respectively, in Method (iii), and so, are not detailed. The surface of the mold used in Method (iv) can be smooth or patterned. The design surface of the interior component obtained by Method (iv) can be surface-treated as described above.

Either Method (iii) or (iv) can be appropriately selected, taking a production cost and/or a production efficiency into consideration.

An automobile interior component of the present invention is excellent in shock resistance and scratch resistance, and therefore, can be suitably used for an interior component such as an audio panel, an air-conditioner panel, a door trim, a navigation panel and a cover lens. If an interior component is less shock-resistant, a person in a car may encounter safety problem in case of automobile crash. An interior component of the present invention is excellent in shock resistance. Therefore, even if an accident occurs, breakage of an interior component can be prevented and protection of the person can be ensured. Furthermore, since an automobile interior component of the present invention is excellent in shock resistance and scratch resistance, it can be used in applications other than an automobile interior component, making use of such characteristics.

### EXAMPLES

The present invention will be further specifically described with reference to Examples.

### Type of a Resin

PC/ABS: an alloy of a bisphenol-A polycarbonate resin and an ABS resin, “Multilon T3750 (black)” from Teijin Limited,
PC-A1: a bisphenol-A polycarbonate resin, “Iupilon S3000R (black)” from Mitsubishi Engineering-Plastics Corporation
PC-A2: a bisphenol-A polycarbonate resin, “Iupilon S3000R (smoke)” from Mitsubishi Engineering-Plastics Corporation
PC-1: a polycarbonate resin containing structural units derived from isosorbide, “DURABIO D7340 (smoke)” from Mitsubishi Chemical Corporation
PC-2: a polycarbonate resin containing structural units derived from isosorbide, “DURABIO D7340 (clear)” from Mitsubishi Chemical Corporation
PC-3: an alloy of a bisphenol-A polycarbonate resin and a bisphenol-C polycarbonate resin, “ lupilon KH341OUR (smoke)” from Mitsubishi Engineering-Plastics Corporation
PC-4: a copolymer of bisphenol A and bisphenol C, “Panlite SH-1126Z (smoke)” from Teijin Limited
PC-5: a polycarbonate resin containing structural units derived from isosorbide, “DURABIO D7340 (black)” from Mitsubishi Chemical Corporation
ABS: an ABS resin, “BULKSAM TM-25 (black)” from UMG ABS Co., Ltd.
PMMA: an acrylic resin (methyl methacrylate homopolymer), “ACRYPET VH (clear)” from Mitsubishi Rayon Co., Ltd.

### Measurement of a Total Light Transmittance

A sample resin was injection-molded by an injection molding machine, to prepare a test piece with a thickness of 2 mm. Its total light transmittance was determined in accordance with JIS K7361-1 (1997). The results are shown in Table 1.

### Shock Resistance Test

Using a DuPont impact tester, shock resistance of a multilayer molded article was evaluated. Specifically, a punch (radius: 6.35 mm) and a die are mounted to the tester, and a multilayer molded article was sandwiched between these such that the surface layer was upper. Then, a 1000 g weight was dropped from a height of 1000 mm, and then the multilayer molded article was removed. The base material and the surface layer were visually observed and evaluated in accordance with the following criteria.

A: No cracks or breakages were observed.

B: In some part, cracks were observed.

C: Breakages were observed.

### Pencil Hardness of a Surface Layer

A pencil hardness of a surface layer in a multilayer molded article was determined in accordance with ASTM D3363. A load was 1 kg, a pencil angle was 45°, a speed was 0.75 mm/s, a distance was 20 mm, and the number of measuring times was 3. The higher a pencil hardness is, the more excellent scratch resistance is.

### Appearance

A surface layer was visually observed and evaluated in accordance with the following criteria.

A: Glossy black

B: Glossy black, but looked slightly whitish

C: Not glossy black

### Chemical Resistance Test

5 mL of isophorone was applied over the whole design surface of a molded article to wet the design surface with isophorone. It was allowed to stand at room temperature for 24 hours. Then, the design surface of the molded article was visually observed and evaluated in accordance with the following criteria.

### Evaluation of solvent cracking

A: No cracks were observed.

B: A few cracks were observed.

C: Many cracks were observed.

### Melting

A: Melting was not observed.

B: Melting was observed.

### Example 1

A mold for a base material was mounted to an injection molding machine (FANUC CORPORATION, FANUC ROBOSHOT α-S150IA), and the above “PC/ABS” was injected into a cavity for a base material formed in this mold (cylinder preset temperature: 250° C., mold temperature: 50° C., injection speed: 30 mm/sec, injection pressure: 200 MPa). After cooling for 40 sec, the base material was removed from the mold. The base material thus obtained was a plate-like molded article with a length of 100 mm, a width of 80 mm and a thickness of 1.5 mm (not shown).

The mold of the injection molding machine (FANUC CORPORATION, FANUC ROBOSHOT α-S150IA) was replaced with a mold for a surface layer, and a base material was mounted to this mold. This mounted base material had been stored at room temperature for one day after preparation as described above. Then, the above “PC-1” was injected into a cavity for a surface layer formed in the mold for a surface layer to form a surface layer on the base material (cylinder preset temperature: 250° C., mold temperature: 80° C., injection speed: 30 mm/sec, injection pressure: 200 MPa). Then, the mold for a surface layer was cooled, and a multilayer molded article was removed from the mold, to provide an insert-molded article. The insert-molded article thus obtained was a plate-like multilayer molded article with a length of 100 mm, a width of 80 mm and a thickness of 4.5 mm (not shown).

### Examples 2 and 3, and Comparative Examples 1 to 4

Insert-molded articles were produced and evaluated as described in Example 1, except that the type of a resin was changed as shown in Table 1, and a cylinder preset temperature, a mold temperature, an injection speed and an injection pressure were changed as shown in Table 2. The evaluation results are shown in Table 1.

TABLE 1

| | Base Material | | | Surface Layer | | | | | | | |
|---|---|---|---|---|---|---|---|---|---|---|---|
| | (Primary Side) | | | (Secondary Side) | | | Evaluation | | | | |
| | | Total Light | | | Total Light | | | | | Chemical | |
| | Resin | Transmittance | Thickness | Resin | Transmittance | Thickness | Shock | Pencil | | Resistance Test | |
| | Type | (%/2 mm) | (mm) | Type | (%/2 mm) | (mm) | Resistance | Hardness | Appearance | Crack | Melting |
| Example 1 | PC/ABS | 0 | 1.5 | PC-1 | 45.70 | 3.0 | A | F | A | A | A |
| Example 2 | PC/ABS | 0 | 1.5 | PC-3 | 46 | 3.0 | A | 2H | A | *1) | *1) |
| Example 3 | PC/ABS | 0 | 1.5 | PC-4 | 44.6 | 3.0 | A | H | A | A | B |
| Comparative | PC/ABS | 0 | 1.5 | PMMA | 92.5 | 3.0 | B | 2H | B | *1) | *1) |
| Example 1 | | | | | | | | | | | |
| Comparative | ABS | 0 | 1.5 | PMMA | 92.5 | 3.0 | C | 2H | B | *1) | *1) |
| Example 2 | | | | | | | | | | | |
| Comparative | ABS | 0 | 1.5 | PC-1 | 45.70 | 3.0 | C | F | A | *1) | *1) |
| Example 3 | | | | | | | | | | | |
| Comparative | ABS | 0 | 1.5 | PC-4 | 44.6 | 3.0 | C | H | A | *1) | *1) |
| Example 4 | | | | | | | | | | | |

*1): not evaluated

TABLE 2

| | Base Material | | | | | Surface Layer | | | | |
|---|---|---|---|---|---|---|---|---|---|---|
| | (Primary Side) | | | | | (Secondary Side) | | | | |
| | | Cylinder | | | | | Cylinder | | | |
| | | Preset | Mold | Injection | Injection | | Preset | Mold | Injection | Injection |
| | Resin | Temperature | Temperature | Speed | Pressure | Resin | Temperature | Temperature | Speed | Pressure |
| | Type | (° C.) | (° C.) | (mm/sec) | (MPA) | Type | (° C.) | (° C.) | (mm/sec) | (MPA) |
| Example 1 | PC/ABS | 250 | 50 | 30 | 200 | PC-1 | 250 | 80 | 30 | 200 |
| Example 2 | PC/ABS | 250 | 50 | 30 | 200 | PC-3 | 280 | 80 | 30 | 200 |
| Example 3 | PC/ABS | 250 | 50 | 30 | 200 | PC-4 | 280 | 80 | 30 | 200 |
| Comparative | PC/ABS | 250 | 50 | 30 | 200 | PMMA | 240 | 80 | 30 | 200 |
| Example 1 | | | | | | | | | | |
| Comparative | ABS | 220 | 50 | 30 | 200 | PMMA | 240 | 80 | 30 | 200 |
| Example 2 | | | | | | | | | | |
| Comparative | ABS | 220 | 50 | 30 | 200 | PC-1 | 250 | 80 | 30 | 200 |
| Example 3 | | | | | | | | | | |
| Comparative | ABS | 220 | 50 | 30 | 200 | PC-4 | 280 | 80 | 30 | 200 |
| Example 4 | | | | | | | | | | |

### Example 4

A molding machine comprising a common mold having a resin injection path for a first color and a molded resin injection path for a second color, a first interchangeable mold and a second interchangeable mold (The

JAPAN STEEL WORKS, LTD., JM600C-2M) was used. First, the above “PC/ABS” was injected into a cavity for a base material formed between the common mold and the first interchangeable mold, to form a primary molded article corresponding to a base material (cylinder preset temperature: 250° C., mold temperature: 50° C., injection speed: 30 mm/sec, injection pressure: 200 MPa).

After cooling for 40 sec, a first interchangeable mold was replaced with a second interchangeable mold. Then, the above “PC-1” was injected into a cavity for a surface layer to form a secondary molded article corresponding to a surface layer on the base material (cylinder preset temperature: 250° C., mold temperature: 80° C., injection speed: 30 mm/sec, injection pressure: 200 MPa). Then, the common mold and the second interchangeable mold were cooled and a molded article was removed from the common mold and the second interchangeable mold, to give a two-color molded article shown in FIG. 1. The two-color molded article obtained was evaluated in accordance with the above criteria. The evaluation results are shown in Table 3.

### Examples 5 to 7, and Comparative Examples 5 to 11

Two-color molded articles were produced and evaluated as described in Example 4, except that the type of a resin was changed as shown in Table 1, and a cylinder preset temperature, a mold temperature, an injection speed and an injection pressure were changed as shown in Table 4. The evaluation results are shown in Table 3.

### Comparative Examples 12 to 15

Molded articles were produced and evaluated as described in Example 4, except that the type of a resin was changed as shown in Table 4, and a cylinder preset temperature, a mold temperature, an injection speed and an injection pressure were changed as shown in Table 2, and a secondary molded article was not formed on the base material. The evaluation results are shown in Table 3.

TABLE 3

| | Base Material | | | Surface Layer | | | | | | | |
|---|---|---|---|---|---|---|---|---|---|---|---|
| | (Primary Side) | | | (Secondary Side) | | | Evaluation | | | | |
| | | Total Light | | | Total Light | | | | | Chemical | |
| | Resin | Transmittance | Thickness | Resin | Transmittance | Thickness | Shock | Pencil | | Resistance Test | |
| | Type | (%/2 mm) | (mm) | Type | (%/2 mm) | (mm) | Resistance | Hardness | Appearance | Crack | Melting |
| Example 4 | PC/ABS | 0 | 2.0 | PC-1 | 45.70 | 2.0 | A | F | A | A | A |
| Example 5 | PC/ABS | 0 | 2.0 | PC-2 | 92 | 2.0 | A | F | B | *1) | *1) |
| Example 6 | PC/ABS | 0 | 2.0 | PC-3 | 46 | 2.0 | A | 2H | A | *1) | *1) |
| Example 7 | PC/ABS | 0 | 2.0 | PC-4 | 44.6 | 2.0 | A | H | A | A | B |
| Comparative | PC-A1 | 0 | 2.0 | PMMA | 92.5 | 2.0 | C | 2H | B | *1) | *1) |
| Example 5 | | | | | | | | | | | |
| Comparative | PC/ABS | 0 | 2.0 | PMMA | 92.5 | 2.0 | B | 2H | B | *1) | *1) |
| Example 6 | | | | | | | | | | | |
| Comparative | ABS | 0 | 2.0 | PMMA | 92.5 | 2.0 | C | 2H | B | *1) | *1) |
| Example 7 | | | | | | | | | | | |
| Comparative | PC-A1 | 0 | 2.0 | PC-1 | 45.70 | 2.0 | C | F | A | *1) | *1) |
| Example 8 | | | | | | | | | | | |
| Comparative | ABS | 0 | 2.0 | PC-1 | 45.70 | 2.0 | C | F | A | *1) | *1) |
| Example 9 | | | | | | | | | | | |
| Comparative | PC-5 | 0.09 | 2.0 | PC-1 | 45.70 | 2.0 | C | F | A | B | A |
| Example 10 | | | | | | | | | | | |
| Comparative | PC-A1 | 0 | 2.0 | PC-A2 | 46 | 2.0 | A | 2B | A | *1) | *1) |
| Example 11 | | | | | | | | | | | |

| | | | | | | | | | |
|---|---|---|---|---|---|---|---|---|---|
| Comparative | PC-A1 | 0 | 2.0 | *1) | A | *1) | D | *1) | *1) |
| Example 12 | | | | | | | | | |
| Comparative | PC/ABS | 0 | 2.0 | *1) | A | *1) | D | *1) | *1) |
| Example 13 | | | | | | | | | |
| Comparative | ABS | 0 | 2.0 | *1) | A | *1) | D | *1) | *1) |
| Example 14 | | | | | | | | | |
| Comparative | PC-2 | 92 | 2.0 | *1) | C | *1) | D | C | A |
| Example 15 | | | | | | | | | |

*1): not evaluated

TABLE 4

| | Base material | | | | | Surface layer | | | | |
|---|---|---|---|---|---|---|---|---|---|---|
| | (primary side) | | | | | (secondary side) | | | | |
| | | Cylinder | | | | | Cylinder | | | |
| | | preset | Mold | Injection | Injection | | preset | Mold | Injection | Injection |
| | Resin | temperature | temperature | speed | pressure | Resin | temperature | temperature | speed | pressure |
| | type | (° C.) | (° C.) | (mm/sec) | (MPA) | type | (° C.) | (° C.) | (mm/sec) | (MPA) |
| Example 4 | PC/ABS | 250 | 50 | 30 | 200 | PC-1 | 250 | 80 | 30 | 200 |
| Example 5 | PC/ABS | 250 | 50 | 30 | 200 | PC-2 | 250 | 80 | 30 | 200 |
| Example 6 | PC/ABS | 250 | 50 | 30 | 200 | PC-3 | 280 | 80 | 50 | 200 |
| Example 7 | PC/ABS | 250 | 50 | 30 | 200 | PC-4 | 300 | 80 | 50 | 200 |
| Comparative | PC-A | 280 | 50 | 40 | 200 | PMMA | 240 | 80 | 30 | 200 |
| Example 5 | | | | | | | | | | |
| Comparative | PC/ABS | 250 | 50 | 30 | 200 | PMMA | 240 | 80 | 30 | 200 |
| Example 6 | | | | | | | | | | |
| Comparative | ABS | 220 | 50 | 30 | 200 | PMMA | 240 | 80 | 30 | 200 |
| Example 7 | | | | | | | | | | |
| Comparative | PC-A | 280 | 50 | 40 | 200 | PC-1 | 250 | 80 | 30 | 200 |
| Example 8 | | | | | | | | | | |
| Comparative | ABS | 220 | 50 | 30 | 200 | PC-1 | 250 | 80 | 30 | 200 |
| Example 9 | | | | | | | | | | |
| Comparative | PC-5 | 250 | 50 | 50 | 200 | PC-1 | 250 | 80 | 30 | 200 |
| Example 10 | | | | | | | | | | |
| Comparative | PC-A | 280 | 50 | 40 | 200 | PC-A | 280 | 80 | 30 | 200 |
| Example 11 | | | | | | | | | | |

| | | | | | | |
|---|---|---|---|---|---|---|
| Comparative | PC-A | 280 | 50 | 40 | 200 | — |
| Example 12 | | | | | | |
| Comparative | PC/ABS | 250 | 50 | 30 | 200 | — |
| Example 13 | | | | | | |
| Comparative | ABS | 220 | 50 | 30 | 200 | — |
| Example 14 | | | | | | |
| Comparative | PC-2 | 250 | 80 | 30 | 200 | — |
| Example 15 | | | | | | |

### DESCRIPTION OF THE REFERENCE NUMERALS

1: interior component
21, 22: through-hole
3: base material
4: surface layer

1. An automobile interior component comprising a base material and a surface layer formed thereon, wherein
the base material is made of an alloy of a bisphenol-A polycarbonate resin and an ABS resin;
the surface layer is made of a polycarbonate resin having a pencil hardness of HB or higher in accordance with ASTM D3363;
a thickness of the surface layer is 0.5 to 5 mm; and
the base material and the surface layer are formed by insert molding or two-color molding such that the surface layer is to be a design surface.

2. The automobile interior component as claimed in claim 1, wherein the surface layer is made of a polycarbonate resin comprising structural units derived from isosorbide; an alloy of a bisphenol-A polycarbonate resin and a bisphenol-C polycarbonate resin; or a polycarbonate resin comprising structural units derived from bisphenol A and bisphenol C.

3. The automobile interior component as claimed in claim 1, wherein a total light transmittance of the base material is 10% or less; and a total light transmittance of the surface layer is 20% or more.

4. The automobile interior component as claimed in claim 3, wherein a total light transmittance of the surface layer is 80% or less.

5. The automobile interior component claim 1, wherein the base material has a through-hole in which the surface layer is absent.

6. The automobile interior component as claimed in claim 5, wherein the surface layer is formed in a part of the through-holes.

7. A method for producing the automobile interior component as claimed in claim 1, comprising
a first step: injecting an alloy of a bisphenol-A polycarbonate resin and an ABS resin into a cavity formed in a mold for a base material, to mold a base material;
a second step: removing the base material from the mold;
a third step: mounting the removed base material on a mold for a surface layer;
a fourth step: injecting a polycarbonate resin having a pencil hardness of HB or higher in accordance with ASTM D3363 into a cavity formed in the mold for a surface layer, to form a surface layer on the base material; and
a fifth step: removing a multilayer molded article from the mold for a surface layer.

8. A method for producing the automobile interior component as claimed in claim 1, comprising
a first step: injecting a polycarbonate resin having a pencil hardness of HB or higher in accordance with ASTM D3363 into a cavity formed in a mold for a surface layer, to form a surface member;
a second step: removing the surface member from the mold;
a third step: mounting the removed surface member on a mold for a base material;
a fourth step: injecting an alloy of a bisphenol-A polycarbonate resin and an ABS resin into a cavity formed in the mold for a base material, to form a base material under the surface member; and
a fifth step: removing a multilayer molded article from the mold for a base material.

9. A method for producing the automobile interior component as claimed in claim 1, comprising
a first step: injecting an alloy of a bisphenol-A polycarbonate resin and an ABS resin into a cavity for a base material formed between a common mold and a first interchangeable mold;
a second step: replacing the first interchangeable mold with a second interchangeable mold;
a third step: injecting a polycarbonate resin having a pencil hardness of HB or higher in accordance with ASTM D3363 into a cavity for a surface layer formed between the common mold and the second interchangeable mold; and
a fourth step: cooling the common mold and the second interchangeable mold, and then removing a multilayer molded article from the common mold and the second interchangeable mold.

10. A method for producing the automobile interior component as claimed in claim 1, comprising
a first step: injecting a polycarbonate resin having a pencil hardness of HB or higher in accordance with ASTM D3363 into a cavity for a surface layer formed between a common mold and a first interchangeable mold;
a second step: replacing the first interchangeable mold with a second interchangeable mold;
a third step: injecting an alloy of a bisphenol-A polycarbonate resin and an ABS resin into a cavity for a base material formed between the common mold and the second interchangeable mold; and
a fourth step: cooling the common mold and the second interchangeable mold, and removing a multilayer molded article from the common mold and the second interchangeable mold.
